(19) United States
(12) Patent Application Publication
(10) Pub. No.: US 2025/0117786 A1
(43) Pub. Date: Apr. 10, 2025

(54) AUTHORIZATION NETWORK AND A METHOD FOR AUTHORIZING A PRELIMINARY TRANSACTION VALUE

(71) Applicant: The Toronto-Dominion Bank, Toronto (CA)

(72) Inventors: Jeffrey Aaron Ecker, Toronto (CA); Dinshaw Bharucha, Toronto (CA); Igor Elkhinovich, Vaughan (CA)

(21) Appl. No.: 18/376,745

(22) Filed: Oct. 4, 2023

(51) Int. Cl. G06Q 20/38; G06Q 20/40; G06Q 30/0226

(52) U.S. Cl. CPC G06Q 20/3829; G06Q 20/4014; G06Q 30/0229

(57) ABSTRACT

An authorization network includes a payment terminal and a loyalty program server. The payment terminal receives a preliminary transaction value, receives an account number from an EMV-compliant payment device, and determines an authorization value from a difference between the preliminary transaction value and a redemption value. The terminal initiates a funds transfer from a customer account associated with the account number in an amount equal to the authorization value by at least transmitting the account number and the authorization value to the payment device, receiving a cryptogram from the payment device, and confirming that the cryptogram was generated from the authorization value and from a cryptographic key uniquely associated with the payment device. The terminal initiates a funds transfer from a funding account to a merchant account by transmitting to the server a redemption request that includes the account number.

### FIELD

This patent application relates to a system and method for authorizing a transaction at a payment terminal.

### BACKGROUND

A consumer might elect at a payment terminal at a merchant's premises to complete a financial transaction with the merchant (e.g. pay for a merchant's goods/services). The consumer might provide the merchant with a loyalty points program card, and instruct the merchant to redeem a portion of the loyalty points that are associated with the loyalty points program card to thereby reduce the amount payable for the transaction. The consumer might then interface a payment card (e.g. credit card or debit card) with the payment terminal to pay the merchant the balance owed. Therefore, in such a transaction, payment of the total transaction amount requires possession of both a payment card and a loyalty points program card.

Moreover, the merchant typically initiates redemption of the loyalty points by simply scanning the account number from the loyalty points program card, and transmitting the account number to a loyalty program server via a loyalty card network that is distinct from the payment network that the payment terminal uses to effect payment for the balance owed. Therefore, access to any accumulated loyalty points is typically only contingent upon possession of an apparently-authentic loyalty points program card.

### SUMMARY

This patent application describes an authorization network and an associated method that authorizes a transaction value using loyalty points that are associated with an EMV-compliant payment device.

In accordance with a first aspect of this disclosure, the authorization network includes a payment terminal and a loyalty program server. The payment terminal is configured with terminal processing instructions that cause the payment terminal to receive a preliminary transaction value, receive an account number from an EMV-compliant payment device that is interfaced with the payment terminal, and determine an authorization value from a difference between the preliminary transaction value and a redemption value.

The terminal processing instructions also cause the payment terminal to initiate a primary funds transfer from a customer account that is associated with the account number in a primary transfer amount that is equal to the authorization value, initiate a secondary funds transfer in a secondary transfer amount that is equal to the redemption value, and generate a redemption request that includes the account number, a merchant identifier and the redemption value.

The terminal processing instructions cause the payment terminal to initiate the primary funds transfer by at least transmitting the account number and the authorization value to the payment device, receiving a cryptogram from the payment device, and confirming that the cryptogram was generated from the authorization value and from a cryptographic key that is uniquely associated with the payment device.

The terminal processing instructions cause the payment terminal to initiate the secondary funds transfer by at least transmitting the redemption request to the loyalty program server. The loyalty program server is configured with server processing instructions that cause the loyalty program server to effect the secondary funds transfer from a funding account to a merchant account that is associated with the merchant identifier. The funding account is distinct from the customer account.

In accordance with a second aspect of this disclosure, the method of authorizing a preliminary transaction value involves a payment terminal receiving the preliminary transaction value, receiving an account number from an EMV-compliant payment device that is interfaced with the payment terminal, and determining an authorization value from a difference between the preliminary transaction value and a redemption value.

The payment terminal initiates a primary funds transfer from a customer account that is associated with the account number in a primary transfer amount that is equal to the authorization value, initiates a secondary funds transfer in a secondary transfer amount that is equal to the redemption value, and generates a redemption request that includes the account number, a merchant identifier and the redemption value.

The payment terminal initiates the primary funds transfer by transmitting the account number and the authorization value to the payment device, receiving a cryptogram from the payment device, and confirming that the cryptogram was generated from the authorization value and from a cryptographic key uniquely associated with the payment device.

The payment terminal initiates the secondary funds transfer by transmitting the redemption request to a loyalty program server. The loyalty program server effects the secondary funds transfer from a funding account to a merchant account that is associated with the merchant identifier. The funding account is distinct from the customer account.

In accordance with a third aspect of this disclosure, the non-transient computer readable medium carries processing instructions stored thereon which, when executed by a processor of a payment terminal, cause the payment terminal to receive a preliminary transaction value, receive an account number from an EMV-compliant payment device that is interfaced with the payment terminal, and determine an authorization value from a difference between the preliminary transaction value and a redemption value.

The processing instructions also cause the payment terminal to initiate a primary funds transfer from a customer account that is associated with the account number in a primary transfer amount that is equal to the authorization value, initiate a secondary funds transfer from a funding account to a merchant account that is associated with the merchant identifier in a secondary transfer amount that is equal to the redemption value, and generate a redemption request including the account number, a merchant identifier and the redemption value.

The processing instructions cause the payment terminal to initiate the primary funds transfer by at least transmitting the account number and the authorization value to the payment device, receiving a cryptogram from the payment device, and confirming that the cryptogram was generated from the authorization value and from a cryptographic key that is uniquely associated with the payment device.

The processing instructions cause the payment terminal to initiate the secondary funds transfer by at least transmitting the redemption request to a loyalty program server. The funding account is distinct from the customer account.

In one implementation, the payment terminal initiates the primary funds transfer by generating an authorization request that includes the account number, the authorization value and the cryptogram, and transmitting the authorization request to a computer server via a payment network. The payment terminal initiates the secondary funds transfer by transmitting the redemption request to the loyalty program server via a loyalty program network that is distinct from the payment network.

In one implementation, prior to generating the redemption request, the payment terminal transmits to the loyalty program server via the loyalty program network an eligibility request that includes the account number. Similarly, prior to generating the redemption request, the loyalty program server locates in a loyalty points program database a loyalty account database ledger that includes the account number and a loyalty points balance, translates the loyalty points balance into a redemption balance value in accordance with a conversion rule, and transmits the redemption balance value to the payment terminal via the loyalty program network in response to the eligibility request. The payment terminal may confirm that the redemption balance value is at least equal to the redemption value.

The payment terminal may confirm the redemption balance value by displaying the redemption balance value on a display device of the payment terminal, receiving via a user input device of the payment terminal an authorization signal authorizing redemption of the redemption value; and determining that the redemption balance value is at least equal to the redemption value.

The loyalty program server may receive the redemption request, translate the redemption value into a redemption amount in accordance with the conversion rule, determine an updated balance value from a difference between the loyalty points balance and the redemption amount, and replace the loyalty points balance with the updated balance value in the located loyalty account database ledger. The loyalty program server may confirm that the loyalty points balance is at least equal to the redemption amount.

As will become apparent from the following discussion, the authorization network determines the loyalty points balance in a loyalty program account, and redeems the loyalty rewards accumulated in the loyalty program account, only after authorizing the authorization value via the associated EMV-compliant payment device (and optionally the issuer server). Since the authorization network, therefore, prevents a customer from accessing loyalty points without first validating the payment device, the solution described and claimed herein improves upon conventional loyalty program redemption solutions by leveraging the payment device validation security features of the EMV process.

Further, since the authorization network determines the loyalty points balance in a loyalty program account and redeems the loyalty rewards accumulated in the loyalty program account preferably only after authenticating the customer, the solution described and claimed herein further improves upon conventional loyalty program redemption solutions by leveraging the customer authentication security features of the EMV process.

### BRIEF DESCRIPTION OF THE DRAWINGS

An exemplary authorization network, payment terminal, and method of authorizing a transaction value will now be described, with reference to the accompanying drawings, in which:

FIG. 1 is a schematic view of the authorization network, depicting a payment terminal, and an issuer server;

FIG. 2 is a schematic view of one of the payment terminals;

FIG. 3 is a schematic view of loyalty program server; and

FIGS. 4a and 4b together comprise a message flow diagram that depicts the method of authorizing a transaction value.

### DETAILED DESCRIPTION

### 1. Authorization Network

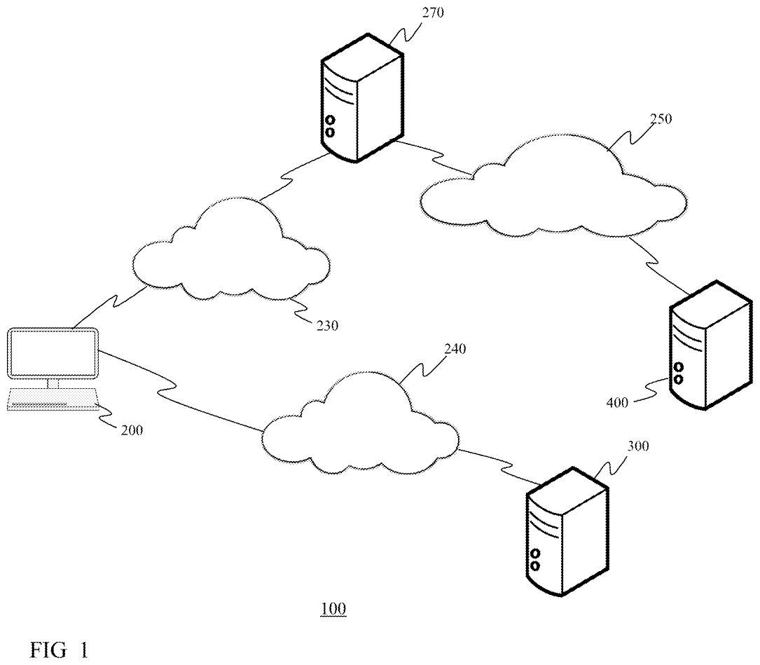

FIG. 1 is a schematic view of the authorization network, denoted generally as 100. As shown, the authorization network 100 comprises a payment terminal 200, an acquirer server 270, a loyalty program server 300, and an issuer server 400, and processes authorization request messages received from the payment terminal 200.

Each payment terminal 200 is typically deployed at a merchant's business premises, and is configured to communicate with one of the acquirer servers 270 and with the loyalty program server 300. Each payment terminal 200 is also configured to communicate with a payment device 210 that the customer may interface with the payment terminal 200. As non-limiting examples, the payment terminal 200 may be implemented as an integrated point-of-sale (POS) terminal, or as a pin-pad terminal that communicates with a respective electronic cash register (ECR).

Each acquirer server 270 may be associated with and administered by a financial institution, and is configured to communicate with the payment terminals 200 that are deployed at each merchant premises via a respective secure communications (acquirer) network 230. Each acquirer server 270 is also configured to communicate with the issuer server 400 via a secure communications (payment) network 250, such as VisaNet or the Mastercard Network.

Each acquirer server 270 maintains a secure financial institution account database that stores a plurality of financial institution account ledgers each associated with a respective merchant. Each financial institution account ledger defines particulars of a respective financial institution account (“merchant account”), and stores an account number, credit/deposit entries to the respective merchant account, and a current balance value of monetary funds maintained in the respective merchant account.

The loyalty program server 300 implements a loyalty points program that rewards loyalty points for goods/services purchased by participants of the loyalty points program and allows those program participants to redeem accumulated loyalty points to reduce the total purchase price of goods/service purchased. The loyalty program server 300 also maintains a financial institution account (“funding account”) at a financial institution on behalf of the loyalty points program, and uses the funding account to effect funds transfers (“secondary funds transfers”) to merchants when participants use their accumulated loyalty points to reduce the total purchase price of goods/service purchased.

The loyalty program server 300 is configured to communicate with the payment terminals 200 via a secure communications (loyalty program) network 240 that is separate and distinct from the payment network 250, and maintains (or is communication with) a secure loyalty account database that stores a plurality of loyalty program account ledgers. Each loyalty program account ledger defines particulars of a respective loyalty program account, and stores an account number, loyalty point reward/redemption entries to the respective loyalty program account, and a current balance of loyalty points maintained in the respective loyalty program account.

Each issuer server 400 may be associated with and administered by a financial institution, and is configured to communicate with the acquirer servers 270 via the payment network 250. The financial institution (“issuer”) associated with the issuer server 400 may issue payment devices 210 to customers of the financial institution or may authorize a third party to issue the payment devices 210 to those customers. Therefore, the issuer server 400 may be provided with a master cryptographic key of each payment device 210 and with a cryptographic key recovery algorithm that allow the issuer server 400 to validate payment devices 210 via cryptograms (e.g. cryptographic session keys) received from the payment devices 210.

The issuer server 400 maintains a secure financial institution account database that stores a plurality of financial institution account ledgers each associated with a respective customer of the financial institution. Each financial institution account ledger defines particulars of a respective financial institution customer account (“customer account”), and stores an account number, credit/deposit entries to the respective customer account, and a current balance value of monetary funds maintained in the respective customer account.

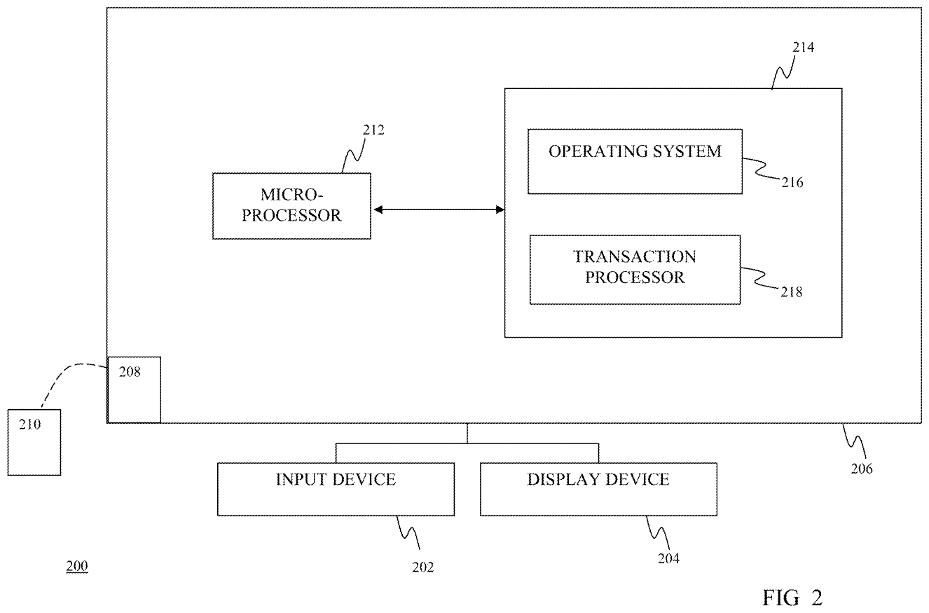

Each payment device 210 (see FIG. 2) is uniquely associated with one of the loyalty program accounts maintained by the loyalty program server 300 and with one of the customer accounts maintained by the issuer server 400. The account number of the loyalty program account may be the same as the account number of the customer account, in which case the payment device 210 may store the account number of the loyalty program and customer account. Alternately, the account number of the loyalty program account may be different from the account number of the customer account, in which case the payment device 210 may store the account number of the customer account, and the loyalty program server 300 may store the account number of the loyalty program account in a database in association with the account number of the customer account.

Although the authorization network 100 is shown comprising only a single payment device 210, a single payment terminal 200 and a single acquirer server 270, the authorization network 100 typically includes a plurality of the payment devices 210, a plurality of the payment terminals 200 and a plurality of the acquirer servers 270. Further, although the acquirer server 270 is shown in FIG. 1 as being separate and distinct from the loyalty program server 300 and the issuer server 400, all or a portion of the functionality of the acquirer server 270 and/or the loyalty program server 300 may be incorporated into and implemented by the issuer server 400.

### 2. Payment Device

The payment device 210 may be implemented as a plastic card that has a contact form factor and/or a contactless (e.g. ISO 14443 based) form factor, and may be implemented as a plastic smartcard, chip card or integrated circuit card that includes a built-in micro-controller and protected memory. The micro-controller and protected memory together provide a secure self-contained computing environment for running cryptographic (e.g. data encryption standard (DES), triple-DES, advanced encryption standard (AES)) algorithms. Preferably, the payment device 210 is implemented as a Europay Mastercard Visa (EMV) payment card that facilitates the authorization of financial transactions, initiated at the payment terminals 200, using the EMV standard. Alternately, the payment device 210 may be implemented in software executing on a portable communications device, such as a smart phone, that is configured to implement payment card requirements of the EMV standard and to facilitate the authorization of financial transactions, initiated at the payment terminals 200, using the EMV standard.

The payment device 210 may be configured with a personal identification number (PIN), a primary account number that is uniquely associated with the payment device 210, and an expiry date and may also store one or more private cryptographic keys and corresponding public certificates. The primary account number and private cryptographic key(s) are uniquely associated with the payment device 210. Each private cryptographic key and the public cryptographic key of the corresponding public certificate comprise an asymmetric cryptographic key pair. Each public certificate is signed by the financial institution (issuer) responsible for the issuance of the payment device 210. The payment device 210 may also be configured with a master cryptographic key that is uniquely associated with the payment device 210, and also configured with a public certificate of the issuer.

Where the payment device 210 is implemented as a plastic card, the PIN, account number, cryptographic key(s) and public certificate(s) may be stored in the protected memory of the payment device 210 prior to delivery of the payment device 210 to the intended user. Where the payment device 210 is implemented in software executing on a portable communications device, the payment device 210 may be configured with the PIN, account number, expiry date, cryptographic key(s), and public certificate(s) when the payment device 210 is installed on the portable communications device.

One or more of the payment devices 210 issued by the issuer may be a “value-added” payment device that is registered with the loyalty points program implemented by the loyalty program server 300. Therefore, the payment device 210 may store an Issuer Identification Number (IIN) that identifies the issuer as the entity responsible for the issuance of the payment device 210 and indicates that the primary account number stored on the payment device 210 is associated with one of the loyalty program accounts maintained by the loyalty program server 300 and with one of the customer accounts maintained by the issuer server 400.

### 3. Payment Terminal

As shown in FIG. 2, the payment terminal 200 includes an input device 202, a display device 204, and a computer processing subsystem 206 that is coupled to the input device 202 and the display device 204. The payment terminal 200 also includes a payment device interface 208 that is coupled to the computer processing subsystem unit 206 and is configured to communicate with a payment device 210 that may be interfaced with the payment device interface 208.

The input device 202 may be implemented as a keyboard, touchpad, touchscreen or other input device suitable for allowing a user of the payment terminal 200 to input data and/or commands that may be required to complete the financial transaction. The display device 204 may be implemented as a liquid crystal display (LCD) panel, cathode ray tube (CRT) display, plasma display panel, or other display device suitable for displaying transaction information to the user.

As discussed, the payment device 210 may have a contact form factor and/or a contactless form factor. If the payment device 210 has a contact form factor, the payment device interface 208 may comprise a physical port (e.g. smartcard reader) that allows the payment terminal 200 to communicate directly with the payment device 210. If the payment device 210 has a contactless form factor, the payment device interface 208 may comprise a wireless interface that allows the payment terminal 200 to communicate with the payment device 210 via a wireless protocol, such as ISO 14443. Alternately, where the payment device 210 is implemented as software within a portable communications device, the payment device interface 208 may be configured to communicate with the payment device 210 using short-range communications protocols, such as Bluetooth and/or Near Field Communications (NFC), as examples.

The computer processing subsystem 206 includes a microprocessor 212 and a non-transient computer-readable medium 214. The non-transient computer-readable medium 214 may be provided as non-volatile electronic computer memory (e.g. FLASH memory) or optical or magnetic memory. The non-transient memory 214 includes computer processing instructions stored therein which, when accessed from the memory 214 and executed by the microprocessor 212, implement an operating system 216 and a transaction processor 218.

The operating system 216 allows the payment terminal 200 to accept user input from the input device 202 and to control the display device 204 and the payment device interface 208.

The operation of the transaction processor 218 will be discussed in greater detail below. However, it is sufficient at this point to note that the transaction processor 218 is configured to receive a preliminary transaction $value, receive an account number from a payment device 210 that is interfaced with the payment terminal 200, determine an authorization value from a difference between the preliminary transaction $value and a redemption $value, and initiate a primary funds transfer from a customer account that is associated with the account number in a primary transfer amount that is equal to the authorization value.

The transaction processor 218 is also configured to generate a redemption request that includes the account number, a merchant identifier and the redemption $value, and initiate a secondary funds transfer in a secondary transfer amount that is equal to the redemption $value. The redemption $value may be equal to or less than the preliminary transaction $value.

The transaction processor 218 initiates the primary funds transfer by at least transmitting the account number and the authorization value to the payment device 210, receiving a cryptogram from the payment device 210, and confirming that the cryptogram was generated from the authorization value and from a cryptographic key that is uniquely associated with the payment device 210. The transaction processor 218 initiates the secondary funds transfer by at least transmitting the redemption request to the loyalty program server 300.

As will be discussed below, the loyalty program server 300 is configured to determine a quantum of the loyalty points that may be rewarded for a particular transaction and to update (using the determined quantum of loyalty points) the current balance of loyalty points maintained in the loyalty program account that is associated with the account number. The quantum of the loyalty points rewarded may be a function of the authorization value. Therefore, the transaction processor 218 may also be configured to also incorporate the authorization value into the redemption request to thereby allow the loyalty program server 300 to determine the quantum of the loyalty points to be rewarded for the transaction.

Although the transaction processor 218 is typically implemented as computer processing instructions, all or a portion of the functionality of the transaction processor 218 may be implemented instead in electronics hardware, such as a field programmable logic gate array (FPGA) or a complex programmable logic device (CPLD).

### 4. Loyalty Program Server

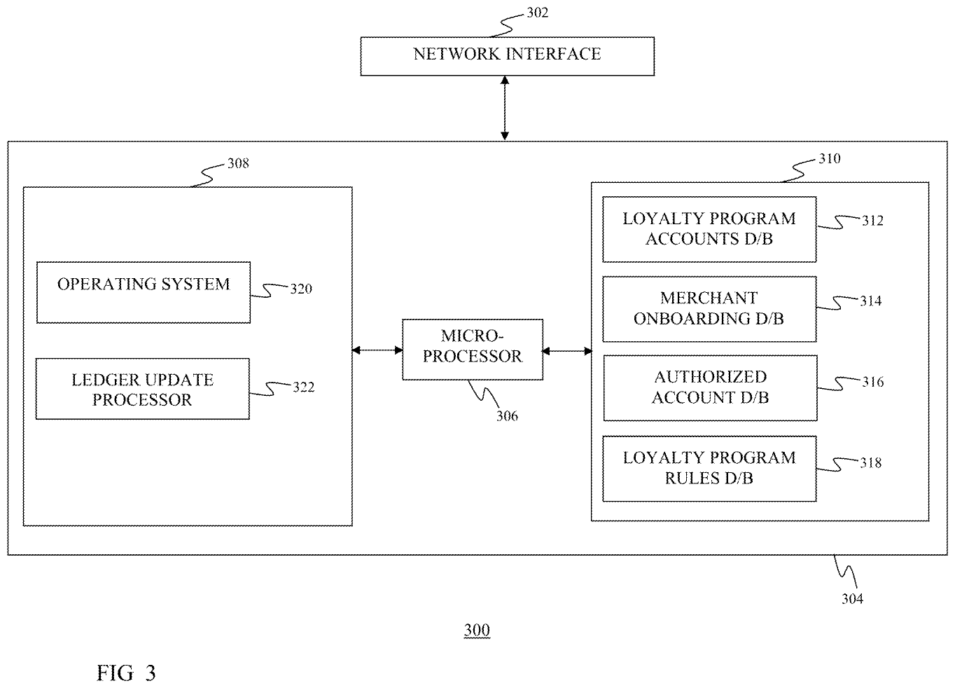

As shown in FIG. 3, the loyalty program server 300 includes a network interface 302, and a data processing subsystem 304 that is coupled to the network interface 302. The network interface 302 interfaces the loyalty program server 300 with the payment terminal(s) 200 via the loyalty program network 240.

The data processing subsystem 304 includes one or more microprocessors 306, a volatile computer-readable memory 308, and a non-transient non-volatile computer-readable medium 310. The non-volatile computer-readable medium 310 may be provided as one or more of a magnetic storage drive and a solid-state drive, and may store a secure loyalty program accounts database 312 and a merchant on-boarding database 314. The non-volatile computer-readable medium 310 may optionally also store an authorized account database 316 and/or a loyalty program rules database 318. Alternately, the loyalty program accounts database 312, the merchant on-boarding database 314, the authorized account database 316, and/or the rules database 318 may be deployed on one more database servers (not shown) that are distinct from the loyalty program server 300, and the loyalty program server 300 may be configured to access the loyalty program accounts database 312, the merchant on-boarding database 314, the authorized account database 316 and/or the rules database 318 via a secure communications channel.

The non-volatile computer-readable medium 310 also maintains computer processing instructions stored thereon which, when copied into the volatile computer-readable memory 308, and executed by the microprocessor(s) 306 from the volatile computer-readable memory 308, define an operating system 320 that controls the overall operation of the loyalty program server 300. The computer processing instructions also implement a ledger update processor 322.

As discussed, the loyalty program server 300 implements a loyalty points program that rewards loyalty points for goods/services purchased by participants of the loyalty points program and allows those program participants to redeem accumulated loyalty points to reduce the total purchase price of goods/service purchased. Therefore, the loyalty program accounts database 312 stores a plurality of loyalty program account ledgers of loyalty program accounts that are enrolled in the loyalty points program. Each loyalty program account ledger stores a loyalty program account number, loyalty point reward/redemption entries to the respective loyalty program account, and a current balance of loyalty points maintained in the respective loyalty program account.

The merchant on-boarding database 314 stores a plurality of merchant on-boarding ledgers. Each merchant on-boarding ledger stores particulars of each merchant participating in the loyalty points program, including a merchant identifier that is uniquely associated with the merchant, and the account number of the merchant account that the merchant's financial institution maintains on behalf of the merchant.

The authorized account database 316 may store one or more ranges and/or lists of the account numbers (“authorized account numbers”) of loyalty program accounts that are enrolled in the loyalty points program. As discussed above, the account number of the loyalty program account may be the same as the account number of the associated customer account. However, the account number of the loyalty program account may be different from the account number of the customer account. In this latter scenario, the authorized account database 316 also stores the account number of the customer account in association with the authorized account number of the associated loyalty program account.

The rules database 318 may store one or more rules that define parameters that the loyalty program server 300 may use to determine the quantum of loyalty points that are being redeemed in a particular transaction and to determine the monetary value of the loyalty points that are available to be redeemed.

The quantum of loyalty points redeemed (“redemption amount”) may be a product a fixed multiplier and the value of a monetary discount (“redemption $value”) that the payment terminal 200 is applying to a transaction. The monetary value of the loyalty points that are available to be redeemed (“redemption balance $value”) may be a product of the inverse of that fixed multiplier and the current balance of loyalty points maintained in a loyalty program account. Therefore, the rules database 318 may identify a fixed multiplier that is applicable to the redemption $value and to the current balance of loyalty points for each transaction.

For example, the rules database 318 may stipulate that the redemption amount redeemed in any transaction is 20× the redemption $value and, therefore, that the redemption balance $value for each transaction is 1/20 (i.e. 5%) of the current balance of loyalty points maintained in the loyalty program account. Alternately, each rule in the rules database 318 may identify a respective range of redemption $values and the multiplier that is applicable to the associated range of redemption $values. Similarly, each rule in the rules database 318 may identify a respective range of current balances of loyalty points and the fractional multiplier that is applicable to the associated range of current loyalty point balances.

Therefore, the ledger update processor 322 is configured to receive, from the payment terminal 200 via the loyalty program network 240, an eligibility request that includes an account number, locate in the loyalty program accounts database 312 the loyalty program account ledger that includes the account number, extract the loyalty points program current balance from the located loyalty program account ledger, translate the extracted loyalty points balance into a redemption balance $value in accordance with the applicable rule specified in the rules database 318, and transmit the redemption balance $value to the payment terminal 200 via the loyalty program network 240 in response to the eligibility request. Preferably, the ledger update processor 322 locates the loyalty program account ledger in the loyalty program accounts database 312 only after confirming that the account number, included in the eligibility request, matches one of the authorized account numbers listed in the authorized account database 316.

The ledger update processor 322 is configured to receive, from the payment terminal 200 via the loyalty program network 240, a redemption request that includes an account number, a merchant identifier and a redemption $value, translate the redemption $value into a redemption amount in accordance with the applicable rule specified in the rules database 318, determine an updated loyalty points balance from a difference between the current loyalty points balance and the redemption amount, and replace the current loyalty points balance with the updated loyalty points balance in the located loyalty program account ledger. Preferably, the ledger update processor 322 determines the updated loyalty points balance and/or replaces the current loyalty points balance with the updated loyalty points balance only after confirming that the current loyalty points balance in the located loyalty program account ledger is at least equal to the redemption amount.

The rules database 318 may also store one or more rules that define parameters that the loyalty program server 300 may use to determine the quantum of the loyalty points to be rewarded for a particular transaction.

As discussed above, the payment terminal 200 is configured to determine an authorization value from a difference between the preliminary transaction $value and the redemption $value. The quantum of the loyalty points rewarded (“loyalty points reward”) may be a function of the authorization value. Therefore, the rules database 318 may identify a fixed fractional multiplier that is applicable to the authorization value for each transaction. For example, the rules database 318 may stipulate that the loyalty points reward for each transaction is 2.5% of the authorization value. Alternately, each rule in the rules database 318 may identify a respective range of authorization values and the fractional multiplier that is applicable to the associated range of authorization values.

The payment terminal 200 may incorporate the authorization value into the redemption request. Therefore, the ledger update processor 322 may be configured to translate the authorization value into a loyalty points reward in accordance with the applicable rule specified in the rules database 318, determine a loyalty points balance from a sum of the current loyalty points balance and the loyalty points reward, and replace the current loyalty points balance with the updated loyalty points balance in the located loyalty program account ledger.

### 5. Method of Authorizing a Transaction Value

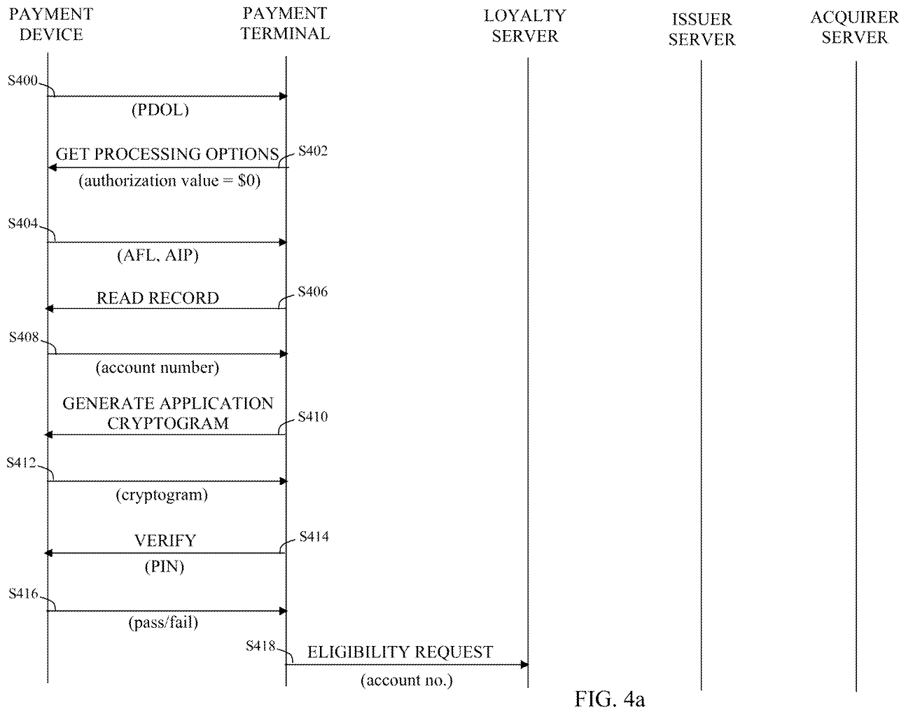

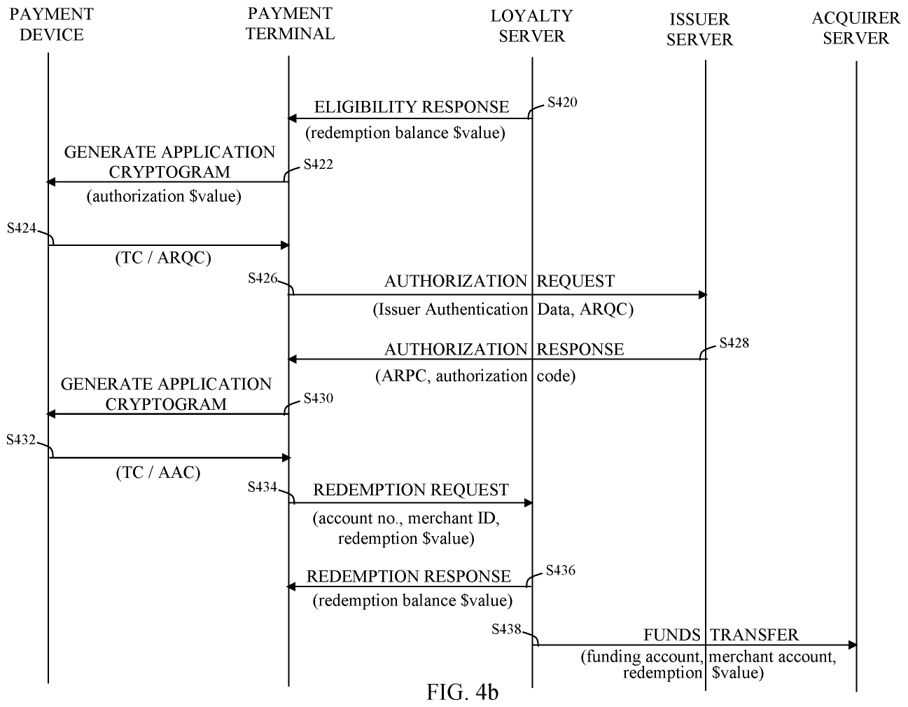

As discussed, the authorization network 100 implements an authorizing method in which one of the payment terminals 200 receives a preliminary transaction $value and dynamically alters (i.e. discounts) the transaction value based in part on a loyalty points balance associated with the payment device 210 interfaced with the payment terminal 200. A sample embodiment of the authorizing method will be discussed with reference to FIGS. 4a and 4b.

As will be explained, in this embodiment the payment terminal 200 receives the preliminary transaction $value and receives an account number from the payment device 210 that is interfaced with the payment terminal 200, determines an authorization value from a difference between the preliminary transaction $value and a redemption $value, and initiates a primary funds transfer from a customer account that is associated with the account number.

The payment terminal 200 initiates the primary funds transfer in a primary transfer amount that is equal to the authorization value. The payment terminal 200 initiates the primary funds transfer by at least transmitting the account number and the authorization value to the payment device, receiving a cryptogram from the payment device, and confirming that the cryptogram was generated from the authorization value and from a cryptographic key uniquely associated with the payment device.

The payment terminal 200 also generates a redemption request that includes the account number, a merchant identifier and the redemption $value. The redemption $value may be less than or equal to the preliminary transaction $value. The payment terminal 200 initiates a secondary funds transfer from the funding account to the merchant account that is associated with the merchant identifier.

The payment terminal 200 initiates the secondary funds transfer in a secondary transfer amount that is equal to the redemption $value. The payment terminal 200 initiates the secondary funds transfer by at least transmitting the redemption request to the loyalty program server 300. The funding account is distinct from the customer account.

An exemplary authorizing method will now be discussed in detail with reference to FIGS. 4a and 4b. In the following example, the payment terminal 200 is configured to implement the EMV standard, and the payment device 210 is implemented as a plastic EMV payment card or as software (executing on a portable communications device) that is configured to implement the EMV standard. The payment terminal 200 stores in the memory 214 thereof the merchant identifier that is uniquely associated with the merchant store in which the payment terminal 200 is located.

In the following example, the account number stored on the payment device 210 is associated with loyalty program account, and the loyalty points balance stored in the associated loyalty account database ledger indicates that the loyalty program account has a balance of 1000 rewards points. Further, the applicable rules stored in the rules database 318 stipulate that (i) the redemption balance $value for each transaction is 1/20 of the current loyalty points balance of loyalty points maintained in the loyalty program account; (ii) the redemption amount redeemed in any transaction is 20× the redemption $value; and (iii) the loyalty points reward for each transaction is 2.5% of the authorization value.

### 5.1. Initiate EMV Session

A customer attends at a payment terminal 200 of a merchant to complete a financial transaction (e.g. pay for goods and/or services) with the merchant. The merchant inputs the pre-discounted total amount payable (preliminary transaction $value) into the payment terminal 200, directly or indirectly via the ECR. The transaction processor 218 of the payment terminal 200 receives the preliminary transaction $value, and prompts the customer to interface an EMV-compliant payment device 210 with the payment terminal 200.

After the customer interfaces the payment device 210 with the payment device interface 208 of the payment terminal 200, at step S400 the payment device 210 initiates an EMV session by providing the payment terminal 200 with a Processing Options Data List (PDOL) that identifies the data elements that the payment device 210 will require to authorize the transaction.

At step S402, the transaction processor 218 transmits to the payment device 210 a Get Processing Options command that includes the data specified in the PDOL. Typically the PDOL includes authorization value as one of the required data elements. Although the payment terminal 200 was provided with the preliminary transaction $value at step S400, the customer might be entitled to a discount to the preliminary transaction $value based in part on the loyalty points balance that may be associated with the account number stored on the payment device 210. Since the actual authorization value therefore is unknown at the stage, at step S402 the transaction processor 218 may set the authorization value datum of the Get Processing Options command to hexadecimal zero.

At step S404, the payment device 210 provides the payment terminal 200 with an Application File Locator (AFL) message that identifies the location(s) in the memory of the payment device 210 of various data elements that the payment terminal 200 may need to authorize the transaction. At step S404, the payment device 210 may also provide the payment terminal 200 with an Application Interchange Profile (AIP) that identifies the capabilities of the payment device 210, such as the type of offline data authentication (discussed below) that the payment device 210 supports.

Using the AFL, at step S406 the transaction processor 218 transmits to the payment device 210 a Read Record command for the various data elements required by the payment terminal 200. Typically, the Read Record command requests at least the account number stored on the payment device 210. The Read Record command may also request a public certificate of the payment device 210 and optionally also a public certificate of the issuer of the payment device 210.

The payment device 210 responds to the payment terminal 200, at step S408, with the account number and any other data requested by the Read Record command. At step S408, the payment device 210 may also provide the payment terminal 200 with a Card Risk Management Data Objects List (CDOL) that identifies the data elements that the payment device 210 may require to generate a cryptogram.

From the expiry date and application version of the software stored on the payment device 210 (as defined in the AIP), the payment terminal 200 may determine whether the payment device 210 is restricted from being used to authorize the financial transaction.

The payment terminal 200 may then validate the payment device 210 based on the type of offline data authentication, if any, identified in the AIP. To do so, at step S410 the transaction processor 218 may transmit to the payment device 210 a Generate Application Cryptogram command, requesting an offline cryptogram from the payment device 210.

If the AIP indicates that the payment device 210 supports Dynamic Data Authentication (DDA) or Combined Data Authentication (CDA), the transaction processor 218 generates an unpredictable number, and includes the unpredictable number in the offline cryptogram request. In response, the payment device 210 generates an offline cryptogram from the unpredictable number and a private cryptographic key of the payment device 210, and provides the payment terminal 200 with the offline cryptogram, at step S412. The transaction processor 218 then uses the public certificate of the issuer of the payment device 210 to validate the public certificate of the payment device 210 (both received in response to the Read Record command), and validates the payment device 210 by using the public certificate of the payment device 210 to verify that the payment device 210 generated the offline cryptogram from a private cryptographic key stored on the payment device 210.

If the AIP indicates that the payment device 210 supports Static Data Authentication (SDA) instead of DDA or CDA, in response to the Read Record command the payment device 210 provides the payment terminal 200 with signed static application data that is stored on the payment device 210. In this scenario, the transaction processor 218 validates the payment device 210 by using the public certificate of the issuer of the payment device 210 to verify that the issuer signed the static application data.

The payment terminal 200 may then authenticate the customer by prompting the customer to input a PIN into the payment terminal 200 via the input device 202. After the customer inputs the PIN into the payment terminal 200, at step S414 the transaction processor 218 transmits to the payment device 210 a Verify command that includes the PIN. The payment device 210 uses the reference PIN that is stored in the protected memory of the payment device 210 to validate the PIN received from the payment terminal 200, and responds to the payment terminal 200 with a validation message, at step S416, indicating whether the PIN received from the payment terminal 200 was successfully validated (i.e. indicating whether the customer is authorized to use the payment device 210).

Although the method has been described thus far as comprising a sequence consisting of at least processing restrictions validation, payment device validation (steps S410 to S412) and customer authentication (steps S414 to S416), it should be understood that the foregoing method may be effected by implementing processing restrictions validation, payment device validation and customer authentication in any order.

### 5.2. Determine Discount Eligibility

As discussed, the loyalty program server 300 may be configured with an authorized account database 316 (or may be in communication with an authorized account database 316) of the account numbers (“authorized account numbers”) of loyalty program accounts that are enrolled in the loyalty points program implemented by the loyalty program server 300. Further, the rules database 318 may store one or more rules that define parameters that the loyalty program server 300 may use to determine the quantum of loyalty points that are available for redemption and the quantum of loyalty points that are being redeemed in a particular transaction. Therefore, after the transaction processor 218 receives the account number from the payment device 210 (received at step S408, in response to the Read Record command, transmitted at step S406), the transaction processor 218 may determine the received account number is an authorized account number (i.e. whether the received account number is associated with a loyalty program account that is enrolled in the loyalty points program).

The transaction processor 218 may determine whether the received account number is an authorized account number without first determining the outcome of restrictions validation, payment device validation and/or customer authentication. However, in attempt to prevent the unauthorized use of a customer's loyalty points, e.g., via a stolen or fraudulent payment device 210, preferably the transaction processor 218 determines whether the received account number is an authorized account number only after successfully completing at least payment device validation and customer authentication. In other words, preferably the transaction processor 218 leverages the security features of the EMV process to determine whether the customer that interfaced the payment device 210 with the payment terminal 200 is actually authorized to access any accumulated loyalty points.

After the transaction processor 218 successfully completes at least payment device validation and customer authentication (i.e validates the payment device 210 and authenticates the customer, if any such prior determinations are required), the transaction processor 218 may generate an eligibility request message that includes the account number. The transaction processor 218 may then transmit the eligibility request message to the loyalty program server 300 via the loyalty program network 240, at step S418, for a determination of whether the account number is associated with a loyalty program account that is enrolled in the loyalty points program. Preferably, the payment terminal 200 transmits the eligibility request message to the loyalty program server 300 without first prompting the customer to approve transmission of the account number over the loyalty program network 240 (i.e. without user intervention).

After the loyalty program server 300 receives the eligibility request message, the ledger update processor 322 of the loyalty program server 300 may query the authorized account database 316 with the account number provided by the payment device 210 to thereby determine whether the provided account number is an authorized account number. Alternately, where the account number associated with the loyalty program account is the same as that associated with the customer account, the ledger update processor 322 may determine whether the provided account number is an authorized account number by querying the loyalty program accounts database 312 with the provided account number.

If the ledger update processor 322 is unable to locate the provided account number in the authorized account database 316 (or in the loyalty program accounts database 312), the ledger update processor 322 generates an eligibility response message that indicates that the account number is not an authorized account number, and transmits the eligibility response message to the payment terminal 200 via the loyalty program network 240, at step S420, in response to the eligibility request message.

However, if the ledger update processor 322 is able to locate the provided account number in the authorized account database 316, and the account number of the loyalty program account is different from the account number of the customer account, the ledger update processor 322 extracts the loyalty program account number that is associated with the provided account number in the authorized account database 316. The ledger update processor 322 then queries the loyalty program accounts database 312 with the loyalty program account number to thereby locate the loyalty account database ledger that is associated with the loyalty program account number. Alternately, where the account number associated with the loyalty program account is the same as that associated with the customer account, the ledger update processor 322 locates the loyalty account database ledger by querying the loyalty program accounts database 312 with the account number provided by the payment device 210.

As discussed above, each loyalty account database ledger includes an account number and a loyalty points balance. Therefore, after the ledger update processor 322 locates the applicable loyalty account database ledger, the ledger update processor 322 extracts the loyalty points balance from the located loyalty account database ledger. The ledger update processor 322 then translates the extracted loyalty points balance into a redemption balance $value in accordance with the applicable rule specified in the rules database 318.

As discussed above, in the current example, the loyalty points balance stored in the located loyalty account database ledger indicates that the loyalty program account has a balance of 1000 rewards points. Further, the applicable rule stored in the rules database 318 stipulates that the redemption balance $value for each transaction is 1/20 (i.e. 5%) of the current loyalty points balance of loyalty points maintained in the loyalty program account. Therefore, in this example, the ledger update processor 322 determines that the redemption balance $value available for this transaction is $50 (5%×1000).

The ledger update processor 322 then generates an eligibility response message that includes the redemption balance $value and optionally also the loyalty points balance (and indicates that the account number is an authorized account number), and transmits the eligibility response message to the payment terminal 200 via the loyalty program network 240, at step S420, in response to the eligibility request message.

### 5.3. Receive Discount Amount (Redemption $Value)

If the eligibility response message received from the loyalty program server 300 indicates that the account number is not an authorized account number, the payment terminal 200 displays a suitable message on the display device 204 thereof. In this scenario, the customer must pay the preliminary transaction $value for the transaction using the customer account that is associated with the account number received from the payment device 210. Therefore, in this scenario, the transaction processor 218 of the payment terminal 200 generates a Generate Application Cryptogram command that includes the preliminary transaction $value, optionally prompts the customer to approve the preliminary transaction $value, and transmits the Generate Application Cryptogram to the payment device 210 for authorization online or offline, in accordance with steps S422 et seq. (discussed below).

However, if the eligibility request message indicates that the account number is an authorized account number, the payment terminal 200 displays on the display device 204 a message that identifies the preliminary transaction $value and the redemption balance $value that is available to reduce the total amount payable (and optionally also displays the loyalty points balance), and prompts the customer to input the portion (if any) of the available redemption balance $value that the customer would like to apply as a discount to the preliminary transaction $value.

The customer may input the desired discount amount (redemption $value) into the payment terminal, via the input device 202. However, if the customer elects to use the entire redemption balance $value in this transaction, the customer may simply input an acknowledgement command, via the input device 202, confirming that the entire redemption balance $value should be applied as a discount to the preliminary transaction $value (i.e. redemption $value=redemption balance $value).

After the payment terminal 200 receives the redemption $value, the transaction processor 218 then determines whether the redemption balance $value is at least equal to the received redemption $value. If the transaction processor 218 determines that the redemption balance $value is less than the received redemption $value, the payment terminal 200 displays an error message on the display device 204 and prompts the customer again to input the portion (if any) of the available redemption balance $value that should be applied as a discount to the preliminary transaction $value.

However, if the transaction processor 218 determines that the redemption balance $value is at least equal to the received redemption $value, the customer must use the customer account that is associated with the account number received from the payment device 210 to pay the balance (if any) of the preliminary transaction $value that is not going to be reduced by the redemption $value. Therefore, in this scenario, the transaction processor 218 computes an authorization $value from the difference between the preliminary transaction $value and the redemption $value, and uses the pending EMV session (initiated at step S400) to initiate a primary funds transfer (from the customer account that is associated with the account number) in a primary transfer amount that is equal to the authorization $value. As will be explained below, the transaction processor 218 may initiate the primary funds transfer by requesting, from the payment device 210, a cryptogram that confirms that payment of the authorization $value from the customer account has been authorized.

### 5.4. Authorize Authorization $Value Offline

The transaction processor 218 may display the authorization $value on the display device 204, and prompt the customer to approve the authorization $value via the input device 202. After the customer approves the authorization $value (if required), the transaction processor 218 uses the results of the processing restrictions validation, payment device validation, and customer authentication (collectively the “Terminal Verification Results”) to determine whether the authorization $value should be authorized online, authorized offline, or declined offline.

As will be appreciated, if the redemption $value is equal to the preliminary transaction $value, the authorization $value=0. In this scenario, instead of proceeding to authorize the authorization $value via the payment device 210, the transaction processor 218 may simply prompt the customer to remove the payment device 210 from the payment terminal 200 and immediately proceed to apply the redemption $value as a discount to the preliminary authorization $value, in accordance with steps S434 et seq. However, in order to properly terminate the EMV session initiated at step S400, and to better leverage at least the payment device validation security features of the EMV process, preferably the transaction processor 218 proceeds to attempt authorization of the $0 authorization $value via the payment device 210, in accordance with steps S422 to S432. Alternately, the transaction processor 218 may decline the $0 authorization $value offline, in accordance with steps S430 to S432.

If the transaction processor 218 determines from the Terminal Verification Results that the authorization $value can be authorized offline, at step S422 the transaction processor 218 generates a Generate Application Cryptogram command and transmits the Generate Application Cryptogram to the payment device 210, requesting a Transaction Certificate (TC) from the payment device 210. Typically, the CDOL (received from the payment device 210 at step S408) lists the authorization value as one of the data elements required by the payment device 210 to generate a cryptogram. Therefore, the transaction processor 218 typically uses the computed authorization $value as the authorization value and, therefore incorporates the computed authorization $value into the Generate Application Cryptogram command. However, if the account number received from the payment device 210 is not an authorized account number (or if the redemption $value=0), the transaction processor 218 uses the preliminary transaction $value as the authorization value and, therefore, incorporates the preliminary transaction $value into the Generate Application Cryptogram command.

After the payment device 210 receives the Generate Application Cryptogram command, the payment device 210 may determine whether the authorization $value can be authorized offline, for example, by verifying that the number of consecutive transactions previously approved offline has not exceeded a predetermined limit.

If the payment device 210 determines that the authorization $value cannot be authorized offline, the payment device 210 provides the payment terminal 200 with a cryptogram ARQC, attempting authorization of the authorization $value online in accordance with steps S422 et seq. (discussed below).

However, if the payment device 210 determines that the authorization $value can be authorized offline, the payment device 210 (i) generates a cryptographic session key from the master cryptographic key, (ii) generates a message authentication code from at least the Terminal Verification Results, the authorization $value and the account number stored on the payment device 210, (iii) generates a cryptogram from the cryptographic session key and the message authentication code, and (iv) generates the certificate TC from the cryptogram and a private cryptographic key of the payment device 210. Since the private cryptographic key is uniquely associated with the payment device 210, the certificate TC is uniquely associated with the payment device 210.

The payment device 210 provides the payment terminal 200 with the certificate TC, at step S424. The payment terminal 200 uses the public certificate of the payment device 210 to confirm that the payment device 210 generated the certificate TC from the authorization $value and the private cryptographic key of the payment device 210 (and, therefore, confirm that the certificate TC is uniquely associated with the authorization $value and the payment device 210 and confirm that the payment device 210 authorized the authorization $value offline). The payment terminal 200 may then provide a notification, on the display device 204, advising the customer that the authorization $value was authorized and instructing the customer to remove the payment device 210 from the payment terminal 200, thereby terminating the EMV session.

### 5.5. Authorize Authorization $Value Online

If the transaction processor 218 determined from the Terminal Verification Results that the authorization $value could not be authorized offline, at step S422 the transaction processor 218 generates a Generate Application Cryptogram command and transmits the Generate Application Cryptogram to the payment device 210, requesting a cryptogram (ARQC) from the payment device 210. As above, the transaction processor 218 typically incorporates the authorization $value into the Generate Application Cryptogram command. However, if the account number received from the payment device 210 is not an authorized account number, the transaction processor 218 incorporates the preliminary transaction $value into the Generate Application Cryptogram command.

After the payment device 210 receives the Generate Application Cryptogram command (or if the payment device 210 determined that the authorization $value could not be authorized offline), the payment device 210 (i) generates a cryptographic session key from the master cryptographic key, (ii) generates a message authentication code from at least the Terminal Verification Results, the authorization $value and the account number stored on the payment device 210 (collectively “Issuer Authorization Data”), and (iii) generates an Application Request Cryptogram (ARQC) from the cryptographic session key and from the message authentication code. Since the master cryptographic key is uniquely associated with the payment device 210, the cryptographic session key and the cryptogram ARQC are uniquely associated with the payment device 210.

The payment device 210 provides the payment terminal 200 with the cryptogram ARQC, at step S424. After the payment terminal 200 receives the cryptogram ARQC, the transaction processor 218 generates an Authorization Request Message that includes the Issuer Authorization Data and the cryptogram ARQC, and transmits the Authorization Request Message to the issuer server 400 at step S426, via the acquirer network 230, acquirer server 270 and payment network 250, for validation.

After the issuer server 400 receives the Authorization Request Message, the issuer server 400 validates the cryptogram ARQC (i.e. validates the payment device 210 by verifying that the payment device 210 generated the cryptogram ARQC from at least the authorization $value). The issuer server 400 may validate the payment device 210 by (i) recovering the session cryptographic key by applying at least the account number and the payment device's master cryptographic key as inputs to a suitable cryptographic key recovery algorithm, (ii) decrypting the cryptogram ARQC with the session cryptographic key, (iii) computing a message authentication code from the Issuer Authorization Data, and (iv) comparing the computed message authentication code against the decrypted cryptogram ARQC.

The issuer server 400 also applies its prevailing risk management rules to the authorization request to determine, for example, whether the authorization $value to is less than the credit/funds balance in the customer account that is associated with the account number.

If the issuer server 400 successfully validates the cryptogram ARQC and confirms that the received authorization request satisfies the prevailing risk management rules, the issuer server 400 reduces the available balance in the customer account that is associated with the account number. The issuer server 400 then (i) generates an authorization response code that indicates the outcome of the cryptogram ARQC validation and the risk management analysis, (ii) generates a message authentication code from the account number, the authorization response code and the cryptogram ARQC, and (iii) generates an Application Response Cryptogram (ARC) from the recovered session cryptographic key and the message authentication code.

The issuer server 400 then generates an Authorization Response Message that includes the Issuer Authorization Data, the authorization response code and cryptogram ARPC, and transmits the Authorization Response Message to the payment terminal 200 at step S428, via the payment network 250, acquirer network 230 and acquirer server 270.

After the payment terminal 200 receives the Authorization Response Message, the transaction processor 218 determines, from the authorization response code, whether the issuer server 270 authorized the authorization $value. If the authorization response code indicates that the issuer server 270 did not authorize the authorization $value, the payment device 210 generates a cryptogram AAC confirming that the authorization of the authorization $value was declined, in accordance with steps S430 et seq. (discussed below).

However, if the authorization response code indicates that the issuer server 270 authorized the authorization $value, at step S430 the transaction processor 218 generates a Generate Application Cryptogram command that includes at least the cryptogram ARPC, and transmits the Generate Application Cryptogram command to the payment device 210, requesting a Transaction Certificate (TC) from the payment device 210.

After the payment device 210 receives the Generate Application Cryptogram command, the payment device 210 validates the cryptogram ARPC (i.e. verifies that the issuer server 400 generated the cryptogram ARPC). The payment device 210 may validate the cryptogram ARPC by (i) decrypting the cryptogram ARPC with the session cryptographic key, (ii) computing a message authentication code from the account number, authorization response code and online cryptogram ARQC, and (iii) comparing the computed message authentication code against the decrypted cryptogram ARPC.

If the payment device 210 successfully validates the cryptogram ARPC, the payment device 210 (i) generates a cryptographic session key from the master cryptographic key, (ii) generates a message authentication code from at least the Terminal Verification Results, the authorization $value and the account number stored on the payment device 210, (iii) generates a cryptogram from the cryptographic session key and the message authentication code, and (iv) generates a certificate TC from the cryptogram and a private cryptographic key of the payment device 210. Since the private cryptographic key is uniquely associated with the payment device 210, the certificate TC is uniquely associated with the payment device 210.

The payment device 210 provides the payment terminal 200 with the certificate TC, at step S432. The payment terminal 200 uses the public certificate of the payment device 210 to confirm that the payment device 210 generated the certificate TC from the authorization $value and the private cryptographic key of the payment device 210 (and, therefore, confirm that the certificate TC is uniquely associated with the authorization $value and the payment device 210 and confirm that the issuer server 400 validated the payment device 210 and authorized the authorization $value online). The payment terminal 200 may then provide a notification, on the display device 204, advising the customer that the authorization $value was authorized and instructing the customer to remove the payment device 210 from the payment terminal 200, thereby terminating the EMV session.

### 5.6. Decline Authorization $Value

If the authorization response code indicated that the issuer server 400 did not authorize the authorization $value (or if the transaction processor 218 determined that the authorization $value should be declined offline), at step S430 the transaction processor 218 generates a Generate Application Cryptogram command that includes at least the Issuer Authorization Data, and transmits the Generate Application Cryptogram command to the payment device 210, requesting an Application Authentication Cryptogram (AAC) from the payment device 210.

After the payment device 210 receives the Generate Application Cryptogram command, the payment device 210 (i) generates a cryptographic session key from the master cryptographic key, (ii) generates a message authentication code from at least the Terminal Verification Results, the authorization $value and the account number stored on the payment device 210, and (ii) generates the cryptogram AAC from the cryptographic session key, the message authentication code and a private cryptographic key of the payment device 210. Since the private cryptographic key is uniquely associated with the payment device 210, the cryptogram AAC is uniquely associated with the payment device 210.

The payment device 210 provides the payment terminal 200 with the cryptogram AAC, at step S432. The payment terminal 200 uses the public certificate of the payment device 210 to confirm that the payment device 210 generated the cryptogram AAC from the authorization $value and the private cryptographic key of the payment device 210 (and therefore confirm that the cryptogram AAC is uniquely associated with the authorization $value and the payment device 210 and confirm that the authorization $value was declined). The payment terminal 200 may then provide a notification, on the display device 204, advising the customer that payment of the authorization $value was declined and instructing the customer to remove the payment device 210 from the payment terminal 200, thereby terminating the EMV session.

### 5.7. Redeem Discount Amount (Redemption $Value)

If the transaction processor 218 receives confirmation that the primary funds transfer in the primary transfer amount (i.e. authorization $value) was authorized (offline or online), the transaction processor 218 generates a redemption request message that includes the account number, the merchant identifier and the redemption $value. Preferably, the transaction processor 218 also incorporates the authorization $value into the redemption request message. The transaction processor 218 then initiates a secondary funds transfer in a secondary transfer amount that is equal to the redemption $value, by transmitting the redemption request message to the loyalty program server 300 via the loyalty program network 240, at step S434.

If the account number of the loyalty program account is different from the account number of the customer account, after the loyalty program server 300 receives the redemption request message the ledger update processor 322 of the loyalty program server 300 extracts the loyalty program account number that is associated with the received account number in the authorized account database 316. The ledger update processor 322 then queries the loyalty program accounts database 312 with the loyalty program account number to thereby locate the loyalty account database ledger that is associated with the loyalty program account number. Alternately, where the account number associated with the loyalty program account is the same as that associated with the customer account, the ledger update processor 322 locates the loyalty account database ledger by querying the loyalty program accounts database 312 with the received account number.

The ledger update processor 322 then translates the redemption $value into a redemption amount in accordance with the applicable rule specified in the rules database 318. As discussed above, in the current example, the applicable rule stored in the rules database 318 stipulates that the redemption amount redeemed in any transaction is 20× the redemption $value. Further, in this example, the redemption $value included in the redemption request message indicates that the customer elected to apply a discount of $40 to the preliminary transaction $value. Therefore, in this example, the ledger update processor 322 determines that the redemption amount being redeemed in this transaction is 800 points (20× $40).

Although the payment terminal 200 confirmed (prior to initiating the primary funds transfer in the authorization $value and prior to transmitting the redemption request message to the loyalty program server 300), that the redemption balance $value was at least equal to the redemption $value, the issuer might have issued multiple payment devices (e.g. amongst the customer's family members) all having the same account number as that provided on the customer's payment device 210. In that scenario, transactions might have been initiated at different payment terminals at substantially the same time and with the same account number, and such different payment terminals 200 might have likewise independently confirmed that the redemption balance $value elected in these transactions was at least equal to the respective redemption $value.

Therefore, in order to prevent the loyalty program account associated with the account number becoming overdrawn due to multiple simultaneous redemption requests, after the ledger update processor 322 locates the loyalty account database ledger that is associated with the account number preferably the ledger update processor 322 also extracts the loyalty points balance (“current loyalty points balance”) from the located loyalty account database ledger. The ledger update processor 322 then determines whether the current loyalty points balance is at least equal to the redemption amount.

As discussed above, in the current example, in response to the redemption request message, the ledger update processor 322 determined that the redemption amount being redeemed in this transaction was 800 points. Therefore, if the ledger update processor 322 determines that the current loyalty points balance is now less than the redemption amount (e.g. another transaction that was initiated using the same account number was approved by the loyalty program server 300 immediately prior to receiving the instant redemption request message), the ledger update processor 322 translates the current loyalty points balance into a current redemption balance $value in accordance with the applicable rule specified in the rules database 318.

As discussed above, the applicable rule stored in the rules database 318 stipulates that the redemption balance $value for each transaction is 1/20 (i.e. 5%) of the current loyalty points balance of loyalty points maintained in the loyalty program account. Therefore, after the ledger update processor 322 determines the current redemption balance $value available for this transaction (in this example, 5%× current loyalty points balance), the ledger update processor 322 generates a redemption response message that includes the current redemption balance $value (and optionally also the current loyalty points balance) and indicates that the current loyalty points balance is insufficient to complete the transaction based on the elected redemption $value. The ledger update processor 322 then transmits the redemption response message to the payment terminal 200 via the loyalty program network 240, at step S436, in response to the redemption request message.

After the payment terminal 200 receives the redemption response message, the payment terminal 200 may display, on the display device 204, an error message that identifies the preliminary transaction $value and the current redemption balance $value (and optionally also displays the current loyalty points balance), and prompts the customer to re-interface the payment device 210 (or interface a new payment device 210) with the payment terminal 200 to thereby initiate a new EMV session for payment of the unpaid balance (i.e. the redemption balance $value).

However, if the ledger update processor 322 determines that the current loyalty points balance is not less than the redemption amount, the ledger update processor 322, computes an updated loyalty points balance from a difference between the current loyalty points balance and the redemption amount. The ledger update processor 322 may also translate the authorization $value (if included in the redemption request message) into a loyalty points reward in accordance with the applicable rule specified in the rules database 318, and increment the computed updated loyalty points balance by the value of the loyalty points reward. The ledger update processor 322 then replaces the current loyalty points balance with the updated loyalty points balance in the loyalty account database ledger.

As discussed above, in this example, the ledger update processor 322 determined that the redemption amount was 800 points. Further, in this example, the current loyalty points balance associated with the account number remains unchanged from that determined after processing the eligibility request message (i.e. 1000 rewards points), and the authorization $value is $80 (after deducting the redemption $value from the preliminary transaction $value). Therefore, in this example, the ledger update processor 322 determines that the updated loyalty points balance=202 points (1000-800+(2.5%×80)), and sets the loyalty points balance in the loyalty account database ledger=202.

The ledger update processor 322 may then translate the updated loyalty points balance into a current redemption balance $value in accordance with the applicable rule specified in the rules database 318. After the ledger update processor 322 determines the current redemption balance $value available after this transaction (in this example, 5%×202 points), the ledger update processor 322 generates a redemption response message that includes the current redemption balance $value (and optionally the updated loyalty points balance) and indicates that the redemption request was processed successfully. The ledger update processor 322 then transmits the redemption response message to the payment terminal 200 via the loyalty program network 240, at step S436, in response to the redemption request message.

The ledger update processor 322 may then locate, in the merchant on-boarding database 314, the merchant on-boarding ledger that includes the merchant identifier (included in the redemption request message), extract the account number of the merchant account from the located merchant on-boarding ledger, and generate an electronic funds transfer message that includes the redemption $value, the account number of the funding account, and the account number of the merchant account. The ledger update processor 322 may then transmit the electronic funds transfer message to the acquirer server 270 at step S438, to thereby initiate completion of the secondary funds transfer, from the funding account to the merchant account, in an amount equal to the secondary transfer amount (i.e. redemption $value).

After the payment terminal 200 receives the redemption response message, the payment terminal 200 may display on the display device 204 a confirmation message that identifies the current redemption balance $value (and optionally the updated loyalty points balance).

Typically, at the end of each business day, the payment terminal 200 may initiate completion of all of the primary fund transfers that were authorized that day, by generating a clearing payload that includes at least the account number and the authorization $value of each transaction that was authorized offline or online, and transmitting the clearing payload to the acquirer server 270 via the merchant's acquirer network 230. The acquirer server 270 may then transmit the clearing payload to the issuer server 400, via the payment network 250, to thereby effect the transfer of the identified funds from the respective customer accounts to the merchant account.

As will be apparent from the foregoing discussion, the authorization network 100 determines the loyalty points balance in a loyalty program account and redeems the loyalty rewards accumulated in the loyalty program account, only after authorizing the authorization $value via the associated EMV-compliant payment device 210 (and optionally the issuer server 400). Since the authorization network 100, therefore, prevents a customer from accessing loyalty points without first validating the payment device 210, the authorization network 100 improves upon conventional loyalty program redemption solutions by leveraging the payment device validation security features of the EMV process.

Further, since the authorization network 100 determines the loyalty points balance in a loyalty program account and redeems the loyalty rewards accumulated in the loyalty program account preferably only after authenticating the customer, the authorization network 100 further improves upon conventional loyalty program redemption solutions by leveraging the customer authentication security features of the EMV process.

1. An authorization network comprising:
a payment terminal; and
a loyalty program server,
wherein the payment terminal is configured with terminal processing instructions that cause the payment terminal to:
receive a preliminary transaction value and receive an account number from an EMV-compliant payment device interfaced with the payment terminal,
determine an authorization value from a difference between the preliminary transaction value and a redemption value, and
initiate a primary funds transfer from a customer account associated with the account number in a primary transfer amount equal to the authorization value, wherein the terminal processing instructions cause the payment terminal to initiate the primary funds transfer by at least:
transmitting the account number and the authorization value to the payment device,
receiving a cryptogram from the payment device, and
confirming that the cryptogram was generated from the authorization value and from a cryptographic key uniquely associated with the payment device;
generate a redemption request including the account number, a merchant identifier and the redemption value,
initiate a secondary funds transfer in a secondary transfer amount equal to the redemption value, wherein the terminal processing instructions cause the payment terminal to initiate the secondary funds transfer by at least transmitting the redemption request to the loyalty program server; and
the loyalty program server is configured with server processing instructions that cause the loyalty program server to:
effect the secondary funds transfer from a funding account to a merchant account associated with the merchant identifier, wherein the funding account is distinct from the customer account.

2. The authorization network according to claim 1, wherein:
the terminal processing instructions cause the payment terminal to initiate the primary funds transfer by at least:
generating an authorization request including the account number, the authorization value and the cryptogram, and
transmitting the authorization request to a computer server via a payment network; and
the terminal processing instructions cause the payment terminal to initiate the secondary funds transfer by at least transmitting the redemption request to the loyalty program server via a loyalty program network distinct from the payment network.

3. The authorization network according to claim 2, further comprising a loyalty points program database, wherein:
the terminal processing instructions cause the payment terminal to transmit to the loyalty program server via the loyalty program network, in advance of generating the redemption request, an eligibility request including the account number;
the server processing instructions cause the loyalty program server to:
locate in the loyalty points program database a loyalty account database ledger including the account number and a loyalty points balance,
translate the loyalty points balance into a redemption balance value in accordance with a conversion rule, and
transmit the redemption balance value to the payment terminal via the loyalty program network in response to the eligibility request; and
the terminal processing instructions cause the payment terminal to confirm that the redemption balance value is at least equal to the redemption value.

4. The authorization network according to claim 3, wherein the terminal processing instructions cause the payment terminal to confirm the redemption balance value by at least:
displaying the redemption balance value on a display device of the payment terminal;
receiving via a user input device of the payment terminal an authorization signal authorizing redemption of the redemption value; and
determining that the redemption balance value is at least equal to the redemption value.

5. The authorization network according to claim 3, wherein the server processing instructions cause the loyalty program server to:
receive the redemption request;
translate the redemption value into a redemption amount in accordance with the conversion rule;
determine an updated balance value from a difference between the loyalty points balance and the redemption amount; and
replace the loyalty points balance with the updated balance value in the located loyalty account database ledger.

6. The authorization network according to claim 3, wherein the server processing instructions cause the loyalty program server to determine the updated balance value by at least confirming that the loyalty points balance is at least equal to the redemption amount.

7. A method of authorizing a preliminary transaction value, the method comprising:
a payment terminal receiving the preliminary transaction value and receiving an account number from an EMV-compliant payment device interfaced with the payment terminal;
the payment terminal determining an authorization value from a difference between the preliminary transaction value and a redemption value, and initiating a primary funds transfer from a customer account associated with the account number in a primary transfer amount equal to the authorization value, wherein the initiating a primary funds transfer comprises the payment terminal transmitting the account number and the authorization value to the payment device, receiving a cryptogram from the payment device, and confirming that the cryptogram was generated from the authorization value and from a cryptographic key uniquely associated with the payment device;
the payment terminal generating a redemption request including the account number, a merchant identifier and the redemption value, and initiating a secondary funds transfer in a secondary transfer amount equal to the redemption value, wherein the initiating a secondary funds transfer comprises the payment terminal transmitting the redemption request to a loyalty program server; and
the loyalty program server effecting the secondary funds transfer from a funding account to a merchant account associated with the merchant identifier, wherein the funding account is distinct from the customer account.

8. The method according to claim 7, wherein:
the initiating a primary funds transfer further comprises the payment terminal generating an authorization request including the account number, the authorization value and the cryptogram, and transmitting the authorization request to a computer server via a payment network; and
the initiating a secondary funds transfer comprises the payment terminal transmitting the redemption request to the loyalty program server via a loyalty program network distinct from the payment network.

9. The method according to claim 8, further comprising, in advance of the generating a redemption request:
the payment terminal transmitting to the loyalty program server via the loyalty program network an eligibility request including the account number;
the loyalty program server locating in a loyalty points program database a loyalty account database ledger including the account number and a loyalty points balance, translating the loyalty points balance into a redemption balance value in accordance with a conversion rule, and transmitting the redemption balance value to the payment terminal via the loyalty program network in response to the eligibility request; and
the payment terminal confirming that the redemption balance value is at least equal to the redemption value.

10. The method according to claim 9, wherein the confirming the redemption balance value comprises:
the payment terminal displaying the redemption balance value on a display device of the payment terminal;
the payment terminal receiving via a user input device of the payment terminal an authorization signal authorizing redemption of the redemption value; and
the payment terminal determining that the redemption balance value is at least equal to the redemption value.

11. The method according to claim 9, further comprising:
the loyalty program server receiving the redemption request;
the loyalty program server translating the redemption value into a redemption amount in accordance with the conversion rule;
the loyalty program server determining an updated balance value from a difference between the loyalty points balance and the redemption amount; and
the loyalty program server replacing the loyalty points balance with the updated balance value in the located loyalty account database ledger.

12. The method according to claim 9, wherein the determining an updated balance value comprises the loyalty program server confirming that the loyalty points balance is at least equal to the redemption amount.

13. A non-transient computer readable medium carrying processing instructions stored thereon which, when executed by a processor of a payment terminal, cause the payment terminal to:
receive a preliminary transaction value and receive an account number from an EMV-compliant payment device interfaced with the payment terminal;
determine an authorization value from a difference between the preliminary transaction value and a redemption value;
initiate a primary funds transfer from a customer account associated with the account number in a primary transfer amount equal to the authorization value, wherein the processing instructions cause the payment terminal to initiate the primary funds transfer by at least:
transmitting the account number and the authorization value to the payment device,
receiving a cryptogram from the payment device, and
confirming that the cryptogram was generated from the authorization value and from a cryptographic key uniquely associated with the payment device;
generate a redemption request including the account number, a merchant identifier and the redemption value; and
initiate a secondary funds transfer from a funding account to a merchant account associated with the merchant identifier in a secondary transfer amount equal to the redemption value, wherein the funding account is distinct from the customer account, and wherein the processing instructions cause the payment terminal to initiate the secondary funds transfer by at least transmitting the redemption request to a loyalty program server.

14. The computer readable medium according to claim 13, wherein:
the processing instructions cause the payment terminal to initiate the primary funds transfer by at least:
generating an authorization request including the account number, the authorization value and the cryptogram, and
transmitting the authorization request to a computer server via a payment network; and
the processing instructions cause the payment terminal to initiate the secondary funds transfer by at least transmitting the redemption request to the loyalty program server via a loyalty program network distinct from the payment network.

15. The computer readable medium according to claim 14, wherein the processing instructions cause the payment terminal to, in advance of generating the redemption request:
transmit to the loyalty program server via the loyalty program network an eligibility request including the account number;
receive a redemption balance value from the loyalty program server via the loyalty program network in response to the eligibility request;
confirm that the redemption balance value is at least equal to the redemption value.

16. The computer readable medium according to claim 15, wherein the processing instructions cause the payment terminal to confirm the redemption balance value by at least:
displaying the redemption balance value on a display device of the payment terminal;
receiving via a user input device of the payment terminal an authorization signal authorizing redemption of the redemption value; and
determining that the redemption balance value is at least equal to the redemption value.
